(19) United States
(12) Patent Application Publication
(10) Pub. No.: US 2007/0224926 A1
(43) Pub. Date: Sep. 27, 2007

(54) Scallop Meat Separation

(76) Inventor: John Trevor Adcock, Lake Entrance (AU)

Correspondence Address: Laurence B Bond;Traskbritt, P O Box 2550, Salt Lake City, UT, 84110, US

(21) Appl. No.: 11/597,083

(22) PCT Filed: May 20, 2005
(86) PCT No.: PCT/AU05/00719

§ 371 Date: Nov. 17, 2006

(30) Foreign Application Priority Data
May 20, 2004 (AU) 2004902689

(51) Int. Cl. A22C 29/04

(52) U.S. Cl. 452/20

(57) ABSTRACT

Apparatus for separating scallop meat from a scallop (10) having two opposed shells (11, 12) connected together along a hinge line (17) including mounting means for mounting the scallop (10) having its two opposed shells (11, 12) held parted to provide an access gap between at least part of the peripheries of the opposed shells (11, 12), a fluid source (30) arranged to direct two high speed fluid streams (35, 36) through the access gap between the peripheries of the shells (11, 12) and into contact with respective inside surfaces of the two shells (11, 12) so that the two fluid streams (35, 36) flow along the inside surfaces of the respective shells (11, 12), and moving means (50) for relatively moving the fluid source (30) in relation to the scallop (10) so that each fluid stream (35, 36) traverses a substantial part of the inside surface of the respective shell (11, 12) sufficient to dislodge the scallop meat from the inside surface of the respect shell (11, 12).

### FIELD OF THE INVENTION

This invention relates to apparatus and methods for separating scallop meat from the scallop shells.

### BACKGROUND OF THE INVENTION

The edible portion, or meat of a scallop comprises the adductor muscle which extends between and is strongly attached to the inside surfaces of the two facing shells of the animal. Some species of scallop also have roe attached to the adductor muscle which is also part of the edible portion to be recovered. The remaining part or “mantle” of the animal is treated as offal and is discarded.

In the past the removal of scallop meat from a scallop has been carried out in different ways. The most common technique involves manual cutting of the scallop meat from the shells. This involves insertion of a cutting blade into a slight gap existing or forced between the peripheries of the two shells, followed by running the knife as closely as possible across the inside surface of one of the shells so as to cut the adductor muscle at or as close as possible to the shell inside surface. This releases the strong force holding the two shells together enabling the two shells to be opened out so that the meat can be easily cut from the other shell surface. In commercial operations, this manual process is costly because of the labour involved.

Another known process for separating the meat from a scallop involves application of heat to the shells while the animal is still alive. This causes the animal to release the hold of the adductor muscle on the inside shell surfaces. The heating process involves partial cooking of the meat and also some loss of moisture and hence loss of saleable meat weight, thus reducing the commercial value of the recovered meat. The heating process is mainly used for smaller species of scallop where the manual removal process would be uneconomic.

Also proposed in the past has been an apparatus for mechanically removing scallop meat from the shells as shown in the present applicant's earlier patent Nos. AU 654015 (U.S. Pat. No. 5,427,567) and AU 551153 (U.S. Pat. No. 4,663,805). These describe the use of cutting blades movable by mechanical means to cut along the inside surfaces of the scallop shells. However, the construction and operation of these mechanical cutting systems can be difficult to successfully achieve and consistently maintain. These references to and descriptions of the applicant's own prior proposals or products are not intended to be, and are not to be construed as, statements or admissions of common general knowledge in the art in Australia or elsewhere.

It is an object of the present invention to provide an apparatus and method for separating scallop meat from the shells which can be effective and efficient in recovering the meat and/or which provides at least a useful alternative to the prior scallop meat separation systems.

### SUMMARY OF THE INVENTION

The apparatus for separating scallop meat according to the present invention includes:

mounting means for mounting a scallop having its two opposed shells held parted to provide an access gap between at least part of the peripheries of the opposed shells,

a fluid source arranged to direct two high speed fluid streams through the access gap between the peripheries of the shells and into contact with respective inside surfaces of the two shells so that the two fluid streams flow along the inside surfaces of the respective shells, and

moving means for relatively moving the fluid source in relation to the scallop so that each fluid stream traverses a substantial part of the inside surface of the respective shell sufficient to dislodge the scallop meat from the inside surface of the respective shell.

The method for separating scallop meat according to the present invention includes the steps of:

mounting a scallop having its two opposed shells held parted to provide an access gap between at least part of the peripheries of the opposed shells,

directing two high speed fluid streams through the access gap between the peripheries of the shells and into contact with respective inside surfaces of the two shells so that tho two fluid streams flow along the inside surfaces of the respective shells, and

relatively moving the directions of the fluid streams in relation to the scallop so that each fluid stream traverses a substantial part of the inside surface of the respective shell sufficient to dislodge the scallop meat from the inside surface of the respective shell.

It will be convenient to further describe the optional and preferred features of the invention in relation to the construction and operation of an apparatus, but this description will enable the corresponding steps of the method of the invention to be also understood.

Preferably the parting of the two shells of the scallop comprises parting the shells about the hinge region of the animal where the two shells are connected together and about which the animal opens and closes the shells when using its adductor muscle to propel the animal through water. The mounting means may include holders which engage with the respective opposed shells and which draw the two shells apart. The holders for example may include suction cups which are applied to the outside surfaces of the shells so as to enable outwardly directed parting forces to be applied to the two shells.

The fluid source is preferably arranged to direct the two high pressure fluid streams, preferably water streams, the two fluid streams being preferably directed through the access gap from the same side of the scallop when viewed from a point which is displaced from the medial plane of the scallop and wheel is on a line orthogonal to the medial plane and passing through the centre of the outside face of one of the shells. Preferably the two high pressure high speed fluid streams are created by respective separate nozzles although it may be possible for a single nozzle to generate the two diverging fluid streams to contact and flow along the inside surfaces of the respective opposed shells. Each of the fluid streams is preferably a substantially linear or substantially one dimensional stream, although it may be possible to generate two dimensional generally planar streams which are ribbon shaped or fan shaped in side view and which are effective to dislodge the scallop meat from the inside surfaces of the shells.

In the preferred embodiment, the fluid streams are directed through the access gap from a position or positions approximately on or close to the medial plane of the scallop with the direction of each fluid stream being at an acute angle to the medial plane so that each stream is diverging from the medial plane where it approaches and reaches contact with the inside surface of the respective shell. Preferably each fluid stream contacts the respective inside surface at a shallow acute angle to a tangent at the profile of the inside surface at the point or points of contact of the fluid stream with the inside surface so as to reduce or minimise bouncing or reflection of the fluid stream off the inside surface and, as a result, promoting flow of the fluid stream along the inside surface. It has been empirically determined that the angle of each fluid stream to the medial plane before contacting the respective inside surface is preferably between about 12° and 20°, and most preferably between about 15° and 17°.

Preferably also the fluid streams are directed towards and at an acute angle to the hinge line so as to enter the access gap from a point or points in the vicinity of or outside the peripheral edges of the shells displaced from the hinge about which the shells are held parted.

The fluid source preferably includes a fluid jet mount which is movable along a path in proximity to the scallop so as to direct the fluid streams against the inside surfaces of the shells and to traverse the fluid streams across the substantial part of the inside surface area as the fluid jet mount moves along the path. Preferably the path of movement of the mount is adjacent the peripheral edge of the scallop so that the fluid streams are directed through the access gap from points just inside, or in relatively close proximity to, or just outside the peripheral shell edges. The path of movement of the fluid jet mount may he a linear path, preferably extending in the medial plane of the scallop so that the fluid streams are directed symmetrically against the respective inside surfaces of the shells throughout the path of travel of the fluid jet mount. If desired, however, the path of movement of the mount may be curvilinear, but still in the medial plane of the scallop, so as to more closely follow the curved peripheral edge shape of the scallop.

Preferably the path of movement of the fluid jet mount is along a line which is further from the peripheral shell edge nearer the shell hinge and is nearer to the peripheral shell edge at the opposite tip of the scallop (i.e. diametrically opposite the hinge). The travel line may be for example at about 10° to the centre line of the scallop, being a line drawn in the medial plane from the centre of the hinge to the diametrically opposite tip of the peripheral shell edge.

Preferably the path of movement of the fluid jet mount is in the direction from the scallop hinge to the opposite tip, although separation of the scallop meat from the shells could be effectively achieved by moving in the opposite direction. However, this opposite direction of movement may lead to more difficulties in removing the separated scallop meat from out of the space between the shells because the inclination of the fluid streams towards the hinge would be tending to force the scallop meat towards the hinge after separation and into the hinge region where the separation of the shell peripheries is less than at the shell periphery diametrically opposite to the hinge.

A linear travel line at about 10° to the centre line has been found to be optimal, at least with a species of scallop tested, because the access gap between the shells is larger at the tip opposite to the hinge than at the hinge and the angled travel line keeps the fluid streams contacting the curved inside surfaces of the shells at an approximately constant angle of incidence throughout the travel of the fluid jet mount from the start of travel nearer the hinge to the end of the travel at the opposite side of the scallop from the hinge.

As an alternative to the movement of the fluid jet mount along a linear or curvilinear path generally at or slightly beyond a peripheral edge of the scallop, the fluid source from which the two high speed fluid streams emerge may be mounted for swivelling or angular movement so as to sweep the fluid stream in a fan shaped traverse with the point of origin of the fluid streams and apex of the fan shape being located at the axis of swivelling movement.

### DESCRIPTION OF PREFERRED EMBODIMENT

Possible and preferred features of the present invention will now be described with particular reference to the accompanying drawings. However it is to be understood that the features illustrated in and described with reference to the drawings are not to be construed as limiting on the scope of the invention. In the drawings:

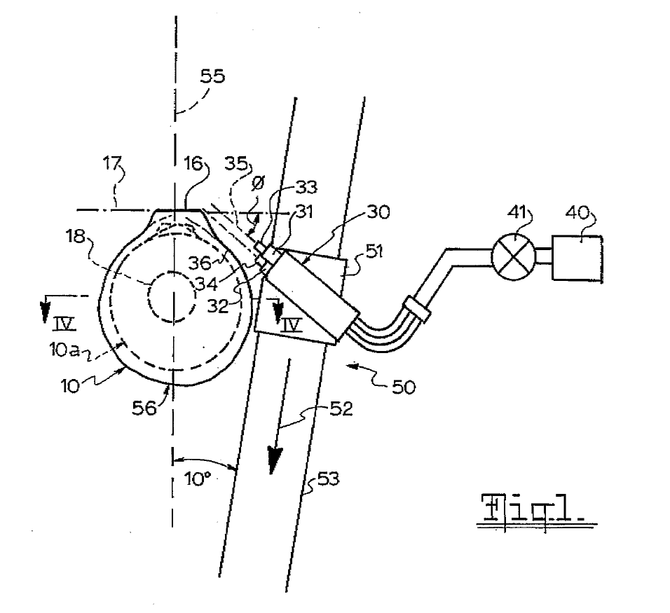

FIG. 1 is a face elevation view of an apparatus according to an embodiment of the present invention,

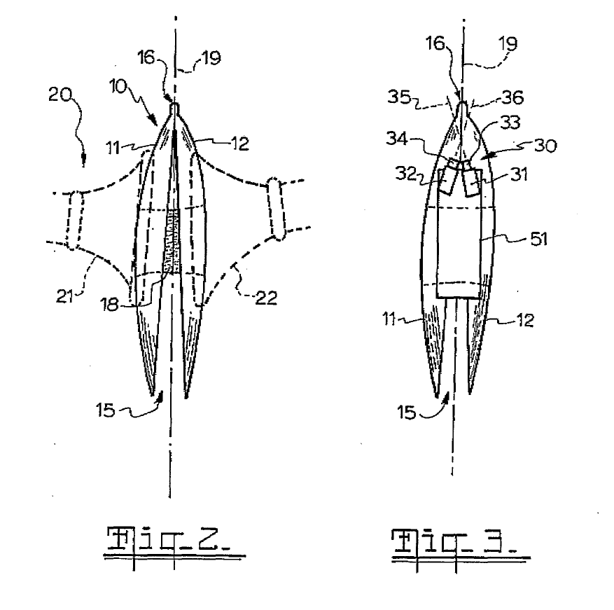

FIG. 2 is an edge elevational view of mounting means mounting a scallop in apparatus according to the invention,

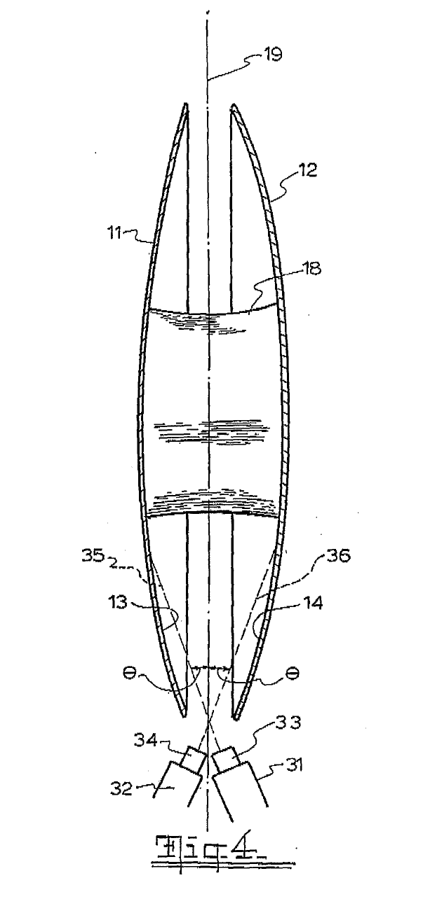

FIG. 3 is an edge elevational view schematically showing the fluid source and fluid streams in relation to the scallop mounted by the mounting means, and

FIG. 4 is a sectional view along the line IV-IV in FIG. 1.

The apparatus in the drawings is shown mounting a scallop 10 having its two shells 11,12 held parted to provide an access gap 15 between the peripheries of the shells. The shells 11, 12 are held parted by mounting means 20 which includes holders 21, 22 which engage with the outside surfaces of the respective shells 11, 12 and draw them apart slightly to create the access gap 15, the holders 21, 22 being illustrated as suction cups. The parting forces applied through the holders 21, 22 draw the shells apart so that they open naturally about the hinge region 16, which extends along a notional hinge line 17. The shells 11, 12 are moved apart on opposite sides of the medial plane 17 so that the edible meat primarily comprising the large adductor muscle 18 is under slight tension and can be seen thorough the gap 15. However, the adductor muscle 18 has a strong holding force on the inside surfaces 13, 14 of the shells 11, 12 so that the extent of the gap 15 that can be created by using suction applied forces to the outside surfaces of the shells is relatively limited.

The means for locating, orienting and for mounting and holding the shells so that they reach and are held in the condition illustrated in FIGS. 2 and 3 need not be described in detail here because they do not form part of the invention (and in fact manual locating and loading of the scallops to the mounting means can be possible). Also, reference may be made to the present applicant's earlier patent specifications for more particular details of scallop shell positioning and mounting means, e.g. AU 728333 (U.S. Pat. No. 6,193,596), the aforementioned specifications AU 551153 and AU 654015, and AU 2004901492.

In the illustrated embodiment, the apparatus includes a fluid source 30 which provides two high pressure water jets 31, 32 which in use direct two high speed fluid streams 35, 36 through the access gap 15 and into contact with the respective inside surfaces 13, 14 (FIG. 4) of the two shells 11, 12 so that the fluid streams flow along the inside surfaces. The water jets 31, 32 are provided with respective separate nozzles 33, 34 which create linear or one dimensional high speed water streams 35, 36. The nozzles 33, 34 for example may have outlet orifices of about 0.8 mm diameter to produce suitable water streams. Any conventional means may be provided for selectively supplying and discontinuing supply of pressurised water to the fluid source 30 as schematically illustrated by water pump 40 which supplies water through a supply line 42 having a switchable control valve 41.

As best seen in FIG. 4, the high pressure high speed water streams 35, 36 are each directed at shallow acute angle θ to the medial plane 19. The shallow acute angle θ is chosen so that the fluid streams 35, 36 have an angle of incidence upon contacting the inside surfaces 13, 14 such that the fluid streams then flow along the inside surfaces without scattering or reflecting off the inside surfaces, whilst still being at a sufficient angle to pass clearly through the access gap 15 and contact the inside surfaces short of the nearest point of the adductor muscle 18. With the species of scallops tested, this acute angle θ is preferably between 15° and 17°.

As best seen in FIG. 1, the water streams 35, 36 are also directed from the sides of the scallop at or slightly beyond the peripheral edges and towards the hinge 16 and at an acute angle φ to the hinge line 17. This inclination of the direction of the water streams 35, 36 is provided so that the streams successfully enter the access gap 15 displaced a distance from the hinge 16 towards which the width of the gap 15 is very small and narrowing. The water streams 35, 36, however, will contact and flow along the inside surfaces 13, 14 before reaching the adductor muscle 18. This can be helpful in dislodging the mantle and which also ensures that the first initial flow of the water stream is not impacting the adductor muscle 18 but starts beyond the adductor muscle and then traverses to reach and progressively dislodge the adductor muscle as will be described later. The angle φ in the illustrated embodiment is about 55°, but this is illustrative only and is not limiting on the invention.

The illustrated apparatus also includes moving means 50 for moving the fluid source 30 including the water jets 31, 32 in relation to the scallop 10 so that each fluid stream 35, 36 traverses a substantial part of the inside surface 13, 14 of the respective shell 11, 12 sufficient to dislodge the adductor muscle 18 constituting the scallop meat from the inside surface of each shell. The moving means 50 includes a fluid jet mount 51 which is movable along a path 52 illustrated by an arrow in proximity to the scallop 10. The fluid source 30 is mounted by the fluid jet mount 51 which may comprise a carriage or the like movable along guide 53 by any suitable moving means (not shown) such as a pneumatic ram acting between the mount 51 and a fixed point. The path 52 defined by the guide 53 is adjacent to the scallop edge so that the nozzles 33, 34 provided by the water jets 31, 32 move along outside but in proximity to the peripheral edges of the scallop. It is possible for the tips of the water jets 31, 32 where the nozzles 33, 34 are provided to actually pass between the parted peripheral edges along part of the path of travel as would happen with the scallop 10 illustrated in FIG. 1 but would not happen with the smaller scallop 10a illustrated in broken lines in FIG. 1. The apparatus need not need modification for processing a different range of sizes (diameters) of scallops, at least within certain limits. For example, a prototype apparatus of the present invention has been successfully used without changing the configuration and path of travel for scallops ranging from about 85 mm in diameter to about 105 mm in diameter.

In the illustrated embodiment, the path 52 of travel of the mount 51 is a linear path in the medial plane 19. This retains the directions of the water streams 35, 36 at the constant required angles θ to contact the inside surfaces 13, 14 of the shells 11, 12 throughout the travel of the mount 51 past the scallop edges.

Referring to the illustrated shell face elevation of FIG. 1 there is a notional centre line 55 which can bee defined as a line extending in the medial plane 19 from the approximate centre of the hinge 16 diametrically through an opposite edge 56 of the shell periphery. As shown in FIG. 1, the path 52 defined by the guide 53 is furthest from the peripheral edge of the scallop 10 nearer to the hinge 16 and is nearest to the centre line 55 at the limit of travel of the mount 51 closer to the opposite edge 56 of the scallop periphery.

In the FIG. 1 embodiment, the linear path 52 of travel of the mount 51 is at an angle of about 10° to the centre line 55 extending from centre of the hinge to the diametrically opposite edge 56. This 10° inclined direction of travel of the mount 51 enables the water streams 35, 36 to traverse the inside surfaces 13, 14 of the shells 11, 12 starting nearer the hinge 16 and ending after having passed the adductor muscle 18 (and in doing so dislodging it from the inside surfaces) ending nearer to the diametrically opposite edge 56. During this traverse in the direction from hinge 16 to opposite edge 56, the dislodgement of the scallop meat from the inside surfaces 13, 14 of the shells will mean that the scallop meat and other tissues including roe and mantle will be separated or substantially completely separated from attachment to the shells with the detached matter being then freely movable. The force of the water streams (and of scattered and reflected turbulent water in the space between the shells) will tend to expel the adductor muscle 18 through the gap between the parted shells 11, 12 on the opposite to that from which the water streams are entering. The ejected matter can be readily collected for further processing such as removal of the mantle as offal. If scallops which had been previously frozen are being processed by the apparatus, and the matter including the adductor muscle between the shells has not been sufficiently thawed before processing, the adductor muscle may effectively be a solid lump which will not be ejected through the gap between the shell peripheries opposite to the fluid nozzles. However, in this case the edible meat can still be readily recovered because the dislodgement of the adductor muscle from the two shells releases the previous strong force holding the shells together against separation so that the shells can easily be further parted or fully separated to retrieve the dislodged scallop meat. In fact, the mounting means including the scallop holders comprised by the suction cups can be operated after release of the strong attachment to further part and if desired totally separate the two shells to enable the dislodged scallop meat to fall out by gravity from between the shells for recovery.

The preferred steps and operations of the method according to the preferred embodiment of the present invention can be readily understood from the preceding description of the apparatus and its functions and operations.

It is to be appreciated that variations in details of the apparatus and method can be provided without departing from the scope of the present invention. Some such variations have been mentioned in passing earlier including for example different apparatus for mounting and holding the scallops with the shells parted to provide the access gap, use of fluid streams other than the preferred water, different configurations of nozzles and the resulting fluid streams produced, different directions from which the fluid streams are directed into the space between the shells to flow along the inside shell surfaces, different directions of traverse or sweep of the fluid streams, and the different angles of inclination and travel of the fluid streams and fluid jet mount.

It will be understood from the preceding description of the preferred embodiment in conjunction with the drawings that the apparatus of the preferred embodiment can provide an effective system for recovering scallop meat. It is found that the adductor muscle is dislodged by the high pressure water streams cleanly along the inside surfaces of the shells with no wastage of commercially valuable edible meat being left attached to the inside surfaces of the shells. The apparatus can reduce or eliminate the high labour costs associated with the prior completely manual separation of edible scallop meat. Also the apparatus and method do not have the partial cooking and weight loss drawbacks of the removal system using heating of the shells.

1. Apparatus for separating scallop meat from a scallop having two opposed shells connected together along a hinge line, the apparatus including:
mounting means for mounting a scallop having its two opposed shells held parted to provide an access gap between at least part of the peripheries of the opposed shells,
a fluid source arranged to direct two high speed fluid streams through the access gap between the peripheries of the shells and into contact with respective inside surfaces of the two shells so that the two fluid streams flow along the inside surfaces of the respective shells, and
moving means for relatively moving the fluid source in relation to the scallop so that each fluid stream traverses a substantial part of the inside surface of the respective shell sufficient to dislodge the scallop meat from the inside surface of the respective shell.

2. Apparatus as claimed in claim 1 wherein the fluid source is arranged to direct the two high pressure fluid streams through the access gap from the same side of the scallop when viewed from a point which is displaced from the medial plane of the scallop and which is on a line orthogonal to the medial plane and passing through the centre of the outside face of one of the shells.

3. Apparatus as claimed in claim 1 wherein the two high pressure high speed 0 fluid streams are created by respective separate nozzles

4. Apparatus as claimed in claim 1 wherein each of the fluid streams is a substantially linear or substantially one dimensional stream.

5. Apparatus as claimed in claim 1 wherein the fluid source is arranged to direct the fluid streams through the access gap from a position or positions, approximately on or close to the medial plane of the scallop with the direction of each fluid stream being at an acute angle to the medial plane so that each stream is diverging from the medial plane where it approaches and reaches contact with the inside surface of the respective shells.

6. Apparatus as claimed in claim 5 wherein each fluid stream contacts the respective inside surface at a shallow acute angle to a tangent at the profile of the inside surface at the point or points of contact of the fluid stream with, the inside surface so as to reduce or minimize bouncing or reflection of the fluid stream off the inside surface and, as a result, promoting flow of the fluid stream along the inside surface.

7. Apparatus as claimed in claim 1 wherein the fluid source is arranged to direct the fluid streams towards and at an acute angle to the hinge line so as to enter the access gap from a point or points in the vicinity of or outside the peripheral edges of the shells displaced from the hinge about which the shells are held parted.

8. Apparatus as claimed in claim 1 wherein the fluid source includes a fluid jet mount which is movable along a path in proximity to the scallop so as to direct the fluid streams against the inside surfaces of the shells and to traverse the fluid streams across the substantial part of the inside surface area as the fluid jet mount moves along the path.

9. Apparatus as claimed in claim 8 wherein the path of movement of the mount is adjacent the peripheral edge of the scallop so that the fluid streams are directed through the access gap from points just inside, or in relatively close proximity to, or just outside the peripheral shell edges.

10. Apparatus as claimed in claim 8 wherein the path of movement of the fluid jet mount extends in the medial plane of the scallop so that the fluid streams are directed symmetrically against the respective inside surfaces of the shells throughout the path of travel of the fluid jet mount.

11. Apparatus as claimed in claim 8 wherein the path of movement of the fluid jet mount is along a line which is further from the peripheral shell edge nearer the shell hinge and is nearer to the peripheral shell edge at the tip of the scallop diametrically opposite the hinge.

12. Apparatus as claimed in claim 11 wherein the travel line is a linear travel line at about 10° to the centre line so that, because the access gap between the shells is larger at the tip opposite to the hinge than at the hinge, the angled travel line keeps the fluid streams contacting the curved inside surfaces of the shells at an approximately constant angle of incidence throughout the travel of the fluid jet mount.

13. Apparatus as claimed in claim 8 wherein the path of movement of the fluid jet mount is in the direction from the scallop hinge to the opposite tip.

14. A method for separating scallop meat from a scallop having two opposed shells connected together along a hinge line, the method including the steps of:
mounting a scallop having its two opposed shells held parted to provide an access gap between at least part of the peripheries of the opposed shells,
directing two high speed fluid streams through the access gap between the peripheries of the shells and into contact with respective inside surfaces of the two shells so that the two fluid streams flow along the inside surfaces of the respective shells, and
relatively moving the directions of the fluid streams in relation to the scallop so that each fluid stream traverses a substantial part of the inside surface of the respective shell sufficient to dislodge the scallop meat from the inside surface of the respective shell.

15. A method as claimed in claim 14 wherein the two fluid streams are directed through the access gap from the same side of the scallop when viewed from a point which is displaced from the medial plane of the scallop and which is on a line orthogonal to the medial plane and passing through the center of the outside face of one of the shells.

16. A method as claimed in claim 14 wherein each of the fluid streams is a substantially linear or substantially one dimensional stream.

17. A method as claimed in claim 14 wherein the fluid streams are directed through the access gap from a position or positions approximately on or close to the medial plane of the scallop with the direction of each fluid stream being at an acute angle to the medial plane so that each stream is diverging from the medial plane where it approaches and reaches contact with the inside surface of the respective shells.

18. A method as claimed in claim 17 wherein each fluid stream contacts the respective inside surface at a shallow acute angle to a tangent at the profile of the inside surface at the point or points of contact of the fluid stream with the inside surface so as to reduce or minimize bouncing or reflection, of the fluid stream off the inside surface and, as a result, promoting flow of the fluid stream along the inside surface.

19. A method as claimed in claim 18 wherein the angle of each fluid stream to the medial plane before contacting the respective inside surface is between about 12° and 20°.

20. A method as claimed in claim 19 wherein the angle is between about 15° and 17°.

21. A method as claimed in claim 14 wherein the fluid streams are directed towards and at an acute angle to the hinge line so as to enter the access gap from a point or points in the vicinity of or outside the peripheral edges of the shells displaced from the hinge about which the shells are held parted
